(19) United States
(12) Patent Application Publication
(10) Pub. No.: US 2005/0003778 A1
(43) Pub. Date: Jan. 6, 2005

(54) Electrical filters

(76) Inventor: John Desmond Ainsworth, Staffordshire (GB)

Correspondence Address: KIRSCHSTEIN, OTTINGER, ISRAEL;& SCHIFFMILLER, P.C., 489 FIFTH AVENUE, NEW YORK, NY, 10017, US

(21) Appl. No.: 10/486,530

(22) PCT Filed: Jun. 18, 2003
(86) PCT No.: PCT/GB03/02607

(30) Foreign Application Priority Data
Dec. 24, 2003 (GB) 0213933.5

(51) Int. Cl. H04B 1/10; H04B 1/16; H04B 1/18

(52) U.S. Cl. 455/213; 455/67.11; 455/307; 455/291

(57) ABSTRACT

An active filter adapted to filter a line containing an electrical waveform, includes an amplifier, a control system, a waveform measuring device and a coupling circuit. The waveform measuring device, in use, provides an input signal to the control system, the control system controlling the amplifier in response to the input signal and the coupling circuit connecting the amplifier to the system to be filtered. The coupling circuit comprises a passive circuit arranged in a four terminal network of restricted form having no poles in its frequency response within its useful bandwidth. Generally, the four terminal network is provided as a ladder circuit, and a primary use of the filter is to filter ac or dc supplies in electrical power systems.

### FIELD OF THE INVENTION

This invention relates to active electrical filters and methods of using such a filter, particularly, but not exclusively, filters for power supply systems.

### BACKGROUND OF THE INVENTION

Many devices are connected to ac and dc power systems and often such devices generate distortion in the voltages and currents in the power system. Unless corrected such distortion is liable to cause interference with other equipment in the power system.

Possible the largest interfering devices are HVDC converters, at ratings of the order of 100 MW to 2000 MW or more. Other devices having lower ratings include converters associated with industrial equipment such as mine-winders and rolling mills.

A method commonly used to reduce interference is to arrange shunt-connected filters at the interfering source between a line and the return of that line. (The return would usually be grounded but need not be). Most of those used at present are in the form of passive filters, that is containing inductors and capacitors, sometimes with added resistors.

Passive filters may be connected in shunt to the ac or dc system and usually comprise series inductor-capacitor tuned arms, tuned to the largest interfering harmonics, and sometimes other relatively broad-band (‘damped’) filter arms (usually with added resistors) to filter higher frequencies. The main function of such a passive filter is to present a low (ideally zero) shunt impedance at interfering frequencies, such that substantially all of the interfering current components are diverted through the filter.

Such prior art passive filters have the disadvantage that the de-tuning effect of ac system frequency changes, typically of several percent, can cause inadequate filtering.

Broad-band (damped) filter arms are less affected by frequency changes, but give relatively weak filtering effect and relatively large losses (and loss capitalisation). These effects become worse if the total fundamental frequency reactive power (or total capacitance) of the filter is required to be small. The cost of passive filters is relatively high.

Active filters are known in which an electronic amplifier is connected to the ac or dc line via a passive coupling circuit, the amplifier being controlled in a closed-loop manner via a measurement of the voltage or current distortion in the ac or dc line, such that the distortion in the ac or dc line is reduced to a small (ideally zero) value.

FIG. 1 shows in a diagrammatic form an example of a known arrangement for one phase of an active ac filter. The interfering source is assumed to be a 12-pulse converter 1, drawing a current IC from an ac system 2 (shown as an EMF at fundamental frequency only, behind an impedance Z). The converter 1 generates a dc voltage on to dc supply rails C, C. Current I_{C} is initially assumed to contain the wanted fundamental current plus harmonics of orders 11, 13, 23, 25 . . . . In the absence of a filter, these harmonic currents cause finite harmonic voltages on the ac system due to the finite impedance Z, which may interfere with supplies to other consumers on the ac system (not shown).

A typical active filter 3 is shown connected in shunt to the ac system supply rails A-A. Active filter 3 includes a control system 4, an amplifier 5, a coupling filter 6 and a sensing means in the form of a measuring current transformer CT provided in association with one of the ac supply rails. The sensing means CT is provided to detect the harmonic currents produced by the dc converter 1 and provides an input to a control system 4 which is, in turn, connected to an amplifier 5. The output of the amplifier drives the two input terminals B, B of a coupling network 6. An output terminal of the network 6 is connected to each of the ac supply rails A, A. The control system 4 and the amplifier 5 are each of a type known in active filter practice. For simplicity, only one phase is shown; for a 3-phase system, three such circuits will normally be required. The control system is assumed to control the amplifier in response to the measured current I_{S} in the ac system such that the harmonics in I_{S} are reduced (ideally) to zero. In this condition, the harmonic current IF delivered to the line by the active filter is equal to the harmonic component in I_{C}.

The connection from the amplifier 5 to the ac line is shown in this example as being via a passive coupling filter 6. Other forms of connection are known, such as a single inductor or capacitor, or even a direct connection, but these all require a large output voltage rating of the amplifier, hence a high amplifier cost, which is generally prohibitive. A known arrangement of the passive coupling filter 6 is shown in FIG. 2, which includes two passive inductor-capacitor filter arms IC1, IC2 connected in parallel, tuned respectively to the two largest ac harmonic currents (11^{th} and 13^{th} harmonics for a 12-pulse converter). If the tuning of these is exact, including exact ac system frequency, the amplifier voltage required at 11^{th} and 13^{th} harmonics is then in theory zero or, in practice, small. These frequencies are known as the “zeros” of the coupling impedance. FIG. 3 shows a graph of the impedance against frequency (in terms of harmonic order) for a typical arrangement. For normal de-tuning effects (principally due to ac system frequency changes) the amplifier voltage required (hence its rating) will clearly increase but amplifier cost may still be acceptable. Nevertheless, the simple coupling filter shown in FIG. 2 will have an impedance which increases relatively rapidly for harmonic frequencies much smaller or larger than 11^{th} or 13^{th}; filtering of such frequencies, for example orders 23, 25 or higher, may then require excessive amplifier voltage, hence amplifier cost.

At a frequency between the two zeros (at about 12^{th} harmonic in the example) the coupling shown exhibits a “pole”, that is a frequency at which its theoretical impedance is infinity, or in practice very large, making filtering impracticable in this frequency region.

It is possible to increase the number of harmonics filtered by increasing the number of parallel arms in the coupling filter. This is not shown but if, for example, the number of parallel branches in the coupling filter of FIG. 2 is increased to four, these may be tuned to harmonic orders 11, 13, 23, 25. The required amplifier voltage at harmonic orders 11, 13, 23, 25 may then be reasonably low. However, frequencies which are not close to these frequencies will again require excessive amplifier voltage. In addition, this arrangement would exhibit further poles in its impedance characteristic, between each pair of zeros so that, for example, filtering of harmonic currents of intermediate orders such as 17 or 19 (which may occur due to various converter unbalances) may also require excessive amplifier voltage, even if these harmonic currents are small.

The coupling circuit as described so far is effectively a two-terminal circuit. It is also known to use a four-terminal coupling circuit in the form of a ladder circuit including both series and shunt elements, for example, where most series elements of the ladder circuit are inductors and most shunt elements are capacitors, and in which at least one series element is an inductor connected in parallel to a capacitor, or at least one shunt element is an inductor connected in series with a capacitor. Specific examples of such arrangements are given in for example Patent WO 89/06879 A1 (Dan), but all of these have at least one pole in their transfer function.

### SUMMARY OF THE INVENTION

According to the invention there is provided an active filter adapted to filter an electrical line containing an electrical waveform, the active filter comprising an amplifier, a control system, a waveform measuring device, and a coupling circuit, the waveform measuring device being adapted to obtain a measure of at least one noise frequency in the electrical waveform and supply the measure of the noise frequency to an input of the control system, the control system being arranged to control the amplifier in response to the input signal, and the coupling circuit connecting the amplifier to the line thereby to control the at least one noise frequency; wherein the coupling circuit comprises a four terminal network of passive components in a ladder circuit configuration arranged such that it does not have any poles in its frequency response within its useful bandwidth.

The ladder circuit configuration is preferably arranged such that it does have at least one zero adapted to occur at or close to the at least one noise frequency.

The ladder circuit configuration can comprise at least three series arms and at least three shunt arms, wherein:
each series arm of said ladder consists of at least one capacitor, or at least one inductor, or a series combination of at least one capacitor and at least one inductor, and
each shunt arm of said ladder circuit consists of at least one capacitor, or at least one inductor, or a parallel combination of at least one capacitor and at least one inductor, and

there is at least one inductor in at least one series arm and at least one inductor in at least one shunt arm and at least one capacitor in at least one series arm and at least one capacitor in at least one shunt arm.

A four-terminal coupling filter in this form is advantageous because the frequency response of the filter is finite within its operating frequency region, hence the required amplifier voltage and current are finite over the whole operating frequency region. As such, the filter can provide more optimum filtering of the system to which it is connected substantially over the bandwidth of the operating region, with an amplifier relatively of low rating.

Coupling arrangements containing a parallel combination of an inductor and a capacitor in a series arm, or a series combination of an inductor and a capacitor in a shunt arm are here excluded because either of these would cause the existence of one or more poles in the coupling filter frequency response.

The line may be part of a power supply system. The power supply system may be an ac or dc power supply system and may be a multiple phase power supply system. Typically the power system to be filtered will be a three phase ac power system.

A control system, a waveform measuring device, and a coupling circuit is provided for each phase of the power system being filtered.

The waveform measuring device may be a current transformer providing a convenient way of detecting the signal within the signal line. Alternatively the waveform measuring device may be a voltage transformer arranged in a shunt configuration with the line; such a voltage transformer may be advantageous in that it will cause the filter to reduce the effect of harmonics originating in the ac system EMF on the busbar voltage, as well as the effect of local load current.

The coupling circuit may further include a transformer, which is advantageous because it provides galvanic isolation of the amplifier from the line which can help to protect the amplifier from electrical surges. Any transformer provided in the coupling circuit may have an iron core or may have an air core.

The two input terminals of the four terminal network are connected to the amplifier. The two output terminals of the four terminal networks are connected between the line and its return conductor. The return conductor may be grounded, or not grounded.

The skilled person will appreciate that as with any filter, the filter according to the present invention will have a useful bandwidth within which useful filtering is obtained and outside which the filter will be relatively ineffective. The filter according to the present invention is characterised in that it does not have any poles in the frequency response of its transfer function within at least the useful bandwidth. This is advantageous, because as the skilled person will appreciate, in theory an infinite (or in practice a very large) voltage would be required from the amplifier to drive the filter at the frequency of the a pole in order to produce filter action. Therefore, it is clearly advantageous to ensure that no poles are present within the frequency response of the useful bandwidth.

Preferably, the filter may have three or more zeros in its frequency response within the useful bandwidth. The filter may of course have any number of zeros; possibly the filter may have 3, 4, 5, 6, 7, 8, 9, 10, or more zeros. For minimum filter cost the optimum number of zeros within the useful bandwidth will be governed in part by the total filter bandwidth required and the expected amplitude distribution of power line harmonics within the bandwidth.

The filter may be provided in association with a switching device which switches at a predetermined frequency. The predetermined frequency may be a multiple of an ac supply frequency. The switching device may be an AC-DC converter. The skilled person will appreciate that noise will be generated by the switching device at harmonics of its switching frequency. The filter according to the present invention may be designed to remove such harmonics from the line. Where the line is an ac power supply system driving a 12-pulse dc converter, the filter may be adapted to remove the principal ac harmonics of orders 11, 13, 23, 25, . . . . Where the line is a dc power system (the waveform comprising a dc bias with noise thereon) driven by a 12-pulse dc converter the filter may be adapted to remove the principal dc harmonics of orders 12, 24, 36 . . . . The skilled person will appreciate that in either case other intermediate harmonics may be present, caused by various unbalances in the dc converter and in the ac system, and may also be required to be filtered.

The filter according to the present invention may be adapted to filter harmonics typically in the range of the 5^{th} harmonic to 49^{th} harmonic for use on the ac side of a converter, or from about 6^{th} to 48^{th} on its dc side. These ranges of harmonics over which the filter may work may correspond to the useful bandwidth referred to herein.

The zeros of the filter may be adapted to occur at approximately the frequencies corresponding to those of the largest harmonic currents caused by the interfering device. Such an arrangement is advantageous because it means that the amplifier voltage required at the frequencies of each such harmonic is therefore small, giving a more efficient amplifier design. It has the further advantage that if the amplifier should fail then the coupling circuit may continue to provide a moderate filtering action, effectively providing passive filters centred on the zeros of the transfer function, since these are the same as the zeros of the coupling output impedance.

The line may be a power supply line and may be at voltages of about the order of tens of volts, hundreds of volts, thousands of volts, tens of thousands of volts, or hundreds of thousands of volts. However, it is envisaged that the filter is particularly suitable for filtering lines at a potential of the order of hundreds of thousands of volts.

According to a second aspect of the invention there is provided a method of filtering a line having a waveform distortion thereon comprising providing an active filter including an amplifier coupled to the line via a passive circuit arranged in a four terminal network, the method comprising detecting a signal on the line and controlling the amplifier to tend to remove unwanted components of the signal present on the line.

Such a method tends to remove the unwanted component of the signal present on the line more efficiently than prior art methods.

The line may carry an ac or a dc supply voltage. Further, the unwanted component may be noise on the line. In particular, the noise may be harmonics on the power supply line.

The method may comprise providing the coupling filter with a frequency response whose transfer functions do not contain any poles within its useful bandwidth. Such a method is advantageous because it reduces the voltage that must be produced by the amplifier in order to remove the unwanted component.

According to a third aspect of the invention there is provided a power supply system fitted with a filter according to the first aspect of the invention.

The power supply may be an ac or dc supply and may be at voltages of about the order of tens of volts, hundreds of volts, thousands of volts, tens of thousands of volts or hundreds of thousands of volts.

### BRIEF DESCRIPTION OF THE DRAWINGS

There now follows by way of example only a detailed description of embodiments of the present invention with reference to the accompanying drawings, in which:

FIG. 1 shows a prior art arrangement of an active ac filter connected to a power system;

FIG. 2 shows a typical prior art form of two-terminal coupling;

FIG. 3 shows an impedance/frequency characteristic of FIG. 2;

FIG. 4 shows an example of a four-terminal coupling arrangement according to the present invention;

FIG. 5 shows the voltage and current transfer functions Z₁₂ and I₁₂ for the arrangement of FIG. 4.

### DETAILED DESCRIPTION OF EMBODIMENTS OF THE INVENTION

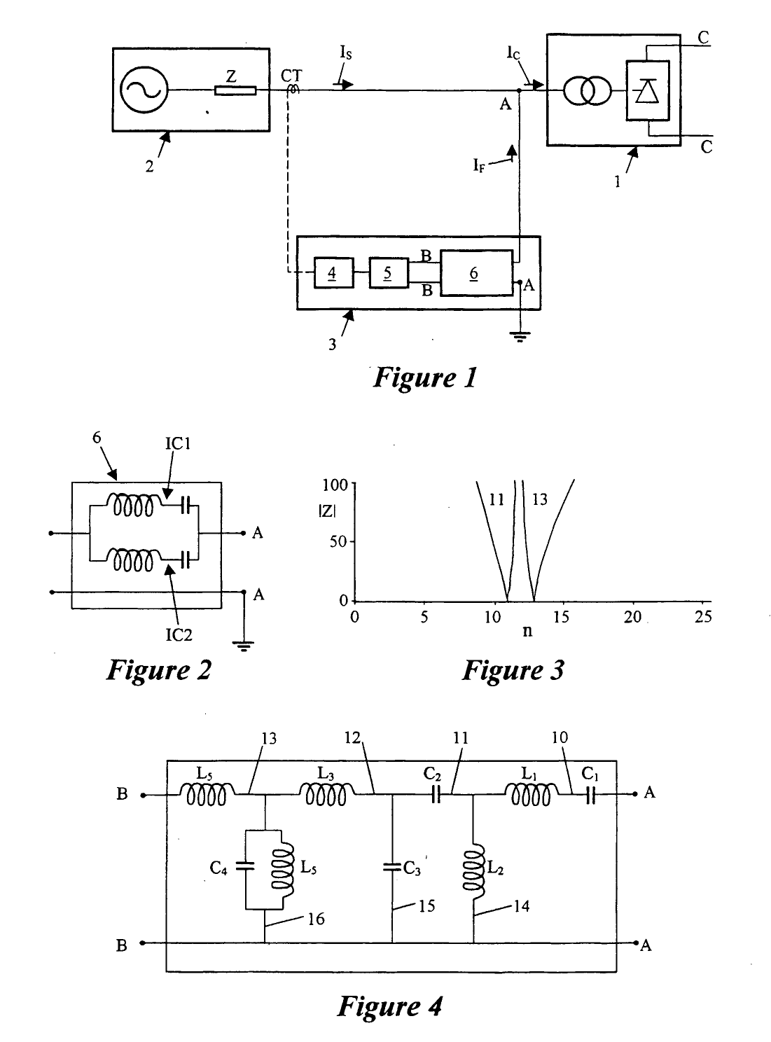

FIG. 4 shows a four terminal coupling network 6′ according to the present invention, suitable for connection in the circuit of FIG. 1 between the amplifier 5 and the ac supply rails A, A. In this example the dc supply rails may be, for example, at a potential of the order of 100 kV to 500 kV.

In use, the dc converter 1 generates interference at a number of harmonic frequencies on to the ac supply rails A, A. These harmonics may damage or cause interference to other electrical equipment supplied by the ac system 2. The active filter 3 is provided within a closed control loop which comprises the sensing means CT, the control system 4, the amplifier 5 and the four terminal network 6. As previously described in FIG. 1, sensing means CT used to sense the waveform in the line was a current transformer connected in series with the line to measure the current in it, but alternatively a voltage transformer connected in shunt to the line could be used to measure the voltage across the line.

The sensing means CT generates a signal representative of the harmonic currents in the ac supply rails A, A and feeds the control system 4. In turn, the control system 4 causes the amplifier 5 to generate an output current which is fed through the four terminal network 6 on to the ac supply rails A, A. The current output from the amplifier 5 is such that the harmonics produced by the converter 1 tend to be cancelled as seen in the ac system 2.

It will be noted that in the coupling circuit embodiment shown in FIG. 4 the four terminal network comprises a ladder circuit having several cascaded sections of various types discussed later. The amplifier is connected to one end of the ladder and the other end is connected to the power system. The principal description below is for an active filter connected to an ac system; the use of an active filter connected to a dc system is generally similar, mentioned later.

From the point of view of amplifier design, the important characteristics of the coupling circuit are the voltage and current transfer functions, defined respectively as:
Z₁₂=amplifier voltage required per 1A at the coupling output into a short-circuit
I₁₂=amplifier current required per 1A at the coupling output into a short circuit, each at a defined frequency or range of frequencies.

The reason for defining these with a short-circuit at the output is that in normal operation, the closed-loop control will (ideally) adjust ac system harmonic current and hence harmonic voltage, to zero at line terminals A, A, which is the same as a short-circuit as seen from the coupling circuit.

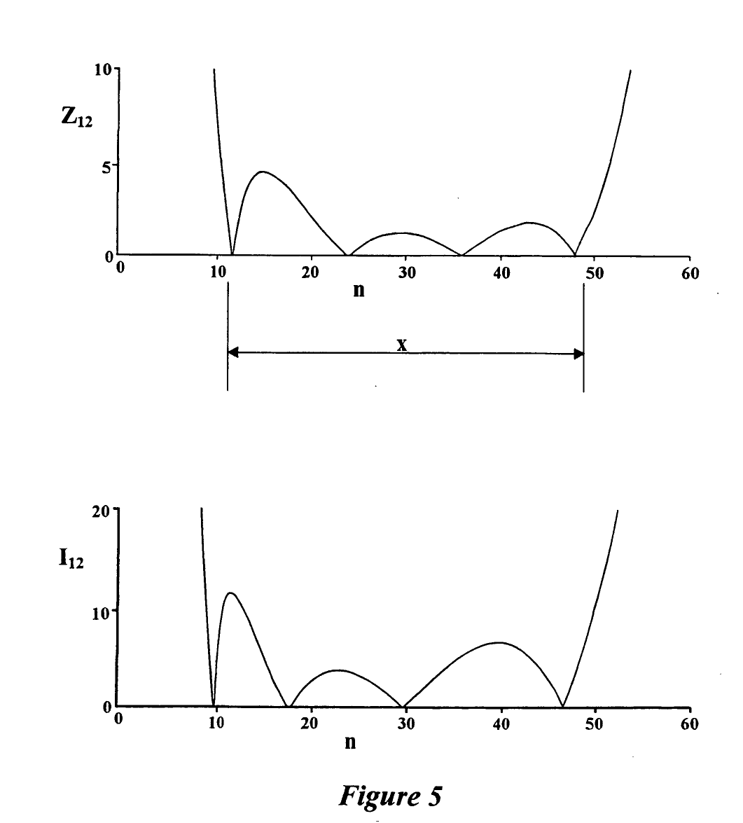

FIG. 5 shows, for the arrangement of FIG. 4, the amplifier voltage transfer function Z₁₂ and the amplifier current transfer function I₁₂. They both have at least three zeros over the useful bandwidth X, Z₁₂ having four zeros at the 12^{th}, 24^{th}, 36^{th} and 48^{th} harmonics, whereas I₁₂ has three zeros within the useful bandwidth X at the 18^{th}, 30^{th}, and 47^{th} harmonics, plus one zero at the 10^{th} harmonic just below the low end of band X.

The coupling circuit 6′ of FIG. 4 contains series arms 10-13 and shunt arms 14-16 in various configurations as an example only. Many alternative configurations for the coupling circuit according to the invention are possible, including circuits which may have 3, 4, 5, 6, or more zeros in their transfer functions.

Series arms may each consist of a single inductor, e.g., L₃, L₅ in arms 12 and 13; or a single capacitor, e.g., C₂ in arm 11; or a series combination of an inductor and a capacitor, e.g., L₁, C₁ in arm 10. Shunt arms may consist of a single inductor, e.g., L₂ in arm 14; a single capacitor, e.g., C₃ in arm 15; or a parallel combination of an inductor and a capacitor, e.g., L₄, C₄ in arm 16.

The use of either:
a series arm containing an inductor and a capacitor in parallel, or:
a shunt arm containing an inductor and a capacitor in series could cause a pole in the voltage and current transfer functions, because either of these would block the flow of signals from the amplifier along the ladder at their resonance frequency; these arrangements are therefore specifically excluded from the present invention. The invention is preferably restricted also to coupling circuits having at least three zeros in both their voltage and current transfer functions.

In general, subject to the restrictions above, various arrangements of the ladder components and their number are possible in principle. However, it will normally be desirable that the total cost of components, including the amplifier and the coupling circuit, shall be as low as possible, particularly in high power equipment. Since this depends on the distribution of the harmonics to be filtered, in amplitudes and frequencies, various different arrangements of components in the coupling circuit may be optimum for different applications in order to minimise cost.

It has been found that arrangements which include components all of one type (such as capacitors or inductors) respectively in either the shunt arms or in the series arms of the ladder do not give an optimum arrangement. The invention is therefore further restricted to a ladder coupling circuit having at least one capacitor in one series arm and at least one inductor in one series arm and similarly at least one inductor in one shunt arm and one capacitor in another shunt arm.

A transformer may be added at any point along the coupling filter, for example at the end B-B next to the amplifier. This may be convenient to provide galvanic isolation and also to provide a “matching ratio” such as to make the relative values of amplifier output voltage and current requirements more convenient in amplifier design. Such a transformer may be iron-cored or air cored; in either case its internal inductances effectively form part of the ladder coupling circuit for design purposes.

The invention may also be applied to an active filter connected across the DC terminals of a ac/dc converter, for example at CC in FIG. 1, in order to suppress harmonic interference on high voltage dc lines. The only significant differences from a filter for ac lines are that (in the case of a 12-pulse HVDC converter) the principal harmonics to be filtered will be of orders 12, 24, 36, . . . , and that the coupling filter must include a series capacitor (shown for example in the example of FIG. 4 as C₁) in the connection to the HVDC line in order to avoid a dc short-circuit.

1-16. (Canceled)

17. An active filter for filtering an electrical line containing an electrical waveform, the active filter comprising: an amplifier, a control system, a waveform measuring device, and a coupling circuit, the waveform measuring device being operative for obtaining a measure of at least one noise frequency in the electrical waveform and for supplying the measure of the at least one noise frequency to an input of the control system, the control system being operative for controlling the amplifier in response to the input signal, and the coupling circuit connecting the amplifier to the line thereby to control the at least one noise frequency, the coupling circuit comprising a four terminal network of passive components in a ladder circuit configuration arranged such that it does not have any poles in its frequency response within its useful bandwidth.

18. The active filter according to claim 17, in which the ladder circuit configuration is arranged such that it has at least one zero occurring at or close to the at least one noise frequency.

19. The active filter according to claim 17, in which the ladder circuit configuration comprises at least three series arms and at least three shunt arms, wherein:
a) each series arm of said ladder circuit configuration consists of at least one capacitor, or at least one inductor, or a series combination of at least one capacitor and at least one inductor, and
b) each shunt arm of said ladder circuit configuration consists of at least one capacitor, or at least one inductor, or a parallel combination of at least one capacitor and at least one inductor, and
c) there is at least one inductor in at least one series arm, and at least one inductor in at least one shunt arm, and at least one capacitor in at least one series arm, and at least one capacitor in at least one shunt arm.

20. The active filter according to claim 17, in which the waveform measuring device is a current transformer connected in series with said line which measures electrical current in said line.

21. The active filter according to claim 17, in which the waveform measuring device is a voltage transformer connected to shunt to said line which measures electrical voltage across said line.

22. The active filter according to claim 17, in which said coupling circuit contains an air-cored transformer.

23. The active filter according to claim 17, in which said coupling circuit contains an iron-cored transformer.

24. The active filter according to claim 17, in which the filter has at least three zeros in its frequency response within the useful bandwidth.

25. The active filter according to claim 17, in which the line is part of a power supply system.

26. The active filter according to claim 25, in which the line carries at least one ac voltage.

27. The active filter according to claim 25, in which the line carries at least one dc voltage.

28. A power supply system including an active filter for filtering an electrical line containing an electrical waveform, the active filter comprising: an amplifier, a control system, a waveform measuring device, and a coupling circuit, the waveform measuring device being operative for obtaining a measure of at least one noise frequency in the electrical waveform and for supplying the measure of the at least one noise frequency to an input of the control system, the control system being operative for controlling the amplifier in response to the input signal, and the coupling circuit connecting the amplifier to the line thereby to control the at least one noise frequency, the coupling circuit comprising a four terminal network of passive components in a ladder circuit configuration arranged such that it does not have any poles in its frequency response within its useful bandwidth.

29. The power supply system according to claim 28, in which the power supply system has multiple phases, and in which the active filter is provided for each phase.

30. The power supply system according to claim 28, including an ac-dc converter.

31. The power supply system according to claim 30, in which the active filter has a useful bandwidth which corresponds to noise frequencies in a range of a fifth harmonic to a forty-ninth harmonic on the ac side of the converter.

32. The power supply system according to claim 30, in which the active filter has a useful bandwidth which corresponds to noise frequencies in a range of a sixth harmonic to a forty-eighth harmonic on the dc side of the converter.
